(19) United States
(12) Patent Application Publication
(10) Pub. No.: US 2026/0211640 A1
(43) Pub. Date: Jul. 23, 2026

(54) DISTRIBUTED CODE GENERATION AND EXECUTION IN THE CLOUD

(71) Applicant: NEC Laboratories America, Inc., Princeton, NJ (US)

(72) Inventors: Kunal Rao, Monroe, NJ (US); Giuseppe Coviello, Robbinsville, NJ (US); Srimat Chakradhar, Manalapan, NJ (US); Ciro DeVita, Princeton, NJ (US); Gennaro Mellone, Napoli (IT)

(21) Appl. No.: 19/447,140

(22) Filed: Jan. 13, 2026

Related U.S. Application Data
(60) Provisional application No. 63/746,352, filed on Jan. 17, 2025.
(60) Provisional application No. 63/747,412, filed on Jan. 21, 2025.

(51) Int. Cl. G06F 8/35

(52) U.S. Cl. CPC G06F 8/35

(57) ABSTRACT

Systems and methods for executing distributed code, including filtering one or more different types of computing devices to perform at least one portion of serial code, wherein the one or more different types of the computing devices pass a performance criteria and ranking the one or more different types of computing devices to optimize for a secondary consideration, the secondary consideration being a heuristic to determine a preferential order of the computing devices for execution of the at least one portion of the serial code. The systems and methods further include distributing the at least one portion of the serial code onto a plurality of the computing devices, the at least one portion of the serial code being allocated to the one or more different types of the computing devices according to a most preferable type of the computing devices available according to the preferential order of the computing devices.

### RELATED APPLICATION INFORMATION

This application claims priority to U.S. Provisional Patent Application No. 63/746,352, filed on Jan. 17, 2025, and U.S. Provisional Patent Application No. 63/747,412, filed on Jan. 21, 2025, incorporated herein by reference in their entirety.

### BACKGROUND

### Technical Field

The present invention relates to generative artificial intelligence and more particularly generating computer code for execution on a distributed infrastructure.

### Description of the Related Art

A large portion of the cost relating to software development is directed towards hiring experts to develop high-quality software and then yet another group of experts to ensure that the software runs efficiently, typically, this is on a distributed infrastructure for modern, complex software with tight integration and interaction with several components.

Large Language Models (LLMs) have the potential to generate software. Consequently, attention has moved towards using LLMs in building complex software to alleviate and subsume some of the costs involved in software development and deployment.

Current implementations of LLM code generation only focus on serial code generation, however. This means the code can only be executed on a single computing device which limits the applicability of LLM code generation because many code bases are implemented in a distributed network. To this end, it is noted these solutions only focus on obtaining correct working code. This is the beginning of solving complex problems, but once there is correct, working code, the preference is for the code to run fast and efficiently.

Further, hardware selected for executing the code is sometimes not optimized for a given parameter or heuristic. In other words, hardware is selected for a given constraint e.g., computing power, without consideration of other factors such as, e.g., energy consumption, execution time, etc.

### SUMMARY

According to an aspect of the present invention, a method is provided for generating and executing distributed code. The method includes filtering, from several types of computing device, one or more different types of computing devices to perform at least one portion of serial code, wherein the one or more different types of the computing devices pass a performance criteria for the at least one portion of the serial code and ranking the one or more different types of computing devices to optimize for a secondary consideration, the secondary consideration being a heuristic to determine a preferential order of the computing devices for execution of the at least one portion of the serial code. The method further includes distributing the at least one portion of the serial code onto a plurality of the computing devices that passes the performance criteria, the at least one portion of the serial code being allocated to the one or more different types of the computing devices according to a most preferable type of the computing devices available according to the preferential order of the computing devices.

According to another aspect of the present invention, a system is provided for generating and executing distributed code. The system includes a processor and a memory storing computer-readable instructions. The memory causes the processor to filter, from several types of computing device, one or more different types of computing devices to perform at least one portion of serial code, wherein the one or more different types of the computing devices pass a performance criteria for the at least one portion of the serial code and rank the one or more different types of computing devices to optimize for a secondary consideration, the secondary consideration being a heuristic to determine a preferential order of the computing devices for execution of the at least one portion of the serial code. The memory further causes the processor to distribute the at least one portion of the serial code onto a plurality of the computing devices that passes the performance criteria, the at least one portion of the serial code being allocated to the one or more different types of the computing devices according to a most preferable type of the computing devices available according to the preferential order of the computing devices.

According to yet another aspect of the present invention, a computer program product is provided for generating and executing distributed code. The computer program product includes computer program code that when executed by one or more processors causes one or more processors to perform operations. The computer program product includes instructions to filter, from several types of computing device, one or more different types of computing devices to perform at least one portion of serial code, wherein the one or more different types of the computing devices pass a performance criteria for the at least one portion of the serial code and rank the one or more different types of computing devices to optimize for a secondary consideration, the secondary consideration being a heuristic to determine a preferential order of the computing devices for execution of the at least one portion of the serial code. The computer program product further includes instructions to distribute the at least one portion of the serial code onto a plurality of the computing devices that passes the performance criteria, the at least one portion of the serial code being allocated to the one or more different types of the computing devices according to a most preferable type of the computing devices available according to the preferential order of the computing devices.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for code generation and execution, in accordance with an embodiment of the present invention;

FIG. 2 is a block diagram illustrating a system for training a Large Language Model (LLM) code generator, in accordance with an embodiment of the present invention;

FIG. 3 is a block diagram illustrating a system for refining a system prompt for LLM code generation, in accordance with an embodiment of the present invention;

FIG. 4 is a block diagram illustrating a system for generating distributed code, in accordance with an embodiment of the present invention;

FIG. 5 is a block diagram illustrating execution of distributed code, in accordance with an embodiment of the present invention;

FIG. 6 is a block diagram illustrating selection of a computing device, in accordance with an embodiment of the present invention;

FIG. 7 is a flow diagram illustrating a method for performing distributed code generation, in accordance with an embodiment of the present invention; and

FIG. 8 is block diagram illustrating a system for generating and executing distributed code, in accordance with an embodiment of the present invention.

### DETAILED DESCRIPTION OF PREFERRED EMBODIMENTS

Embodiments of the present invention can include a large language model (LLM) based tool which automatically generates a distributed version of code and a component that understands the program semantics and executes independent tasks within the program on a cluster of computing devices. Other solutions to optimize LLM generated code have attempted to generate parallel code but focus on low-level parallelization such as optimizing for multiple cores or unique characteristics of the central processing units (CPU) or graphics processing unit (GPU) architecture. Embodiments of the present invention take advantage of multiple computing devices, each having GPUs to distribute execution of code. Though use of multiple computing devices is not necessary. Further embodiments of the present invention select computing devices for particular code to optimize for a given criteria such as, e.g., computing power (raw power, e.g., number of cores), runtime/throughput, cost (e.g., per-hour third-party cloud cost), availability (computing devices available for use), power efficiency (e.g., performance per watt), memory capacity, memory bandwidth, interconnect/multi-GPU scaling, precision support, physical constraints, software ecosystem, latency, etc.

In an embodiment of the present invention, the computing devices can be clusters, computers, edge devices, internet of things (IoT) devices, servers, setups, machines, etc. Each computing device can be a GPU, CPU, tensor processing unit (TPU), neural processing unit (NPU), other application specific integrated circuit (ASIC), field programmable gate array (FPGA), etc., or any combination thereof. The specific hardware that the computing device is housed on can be located at a single location or at several locations or a combination thereof.

In embodiments of the present invention, the LLM-based tool analyzes dependencies in the serial code and at a high-level evaluates whether there are opportunities to implement the same tasks in parallel. Once these opportunities are discovered, the code is marked with semantics so that the code can be performed on several computing devices. In other words, the program can have one set of processes performed on a different device than other processes and the devices know which portion to execute based on indications in the code.

For example, an Application Programming Interface (API) and other finer granularity/low-level compiler optimization techniques, e.g., vectorization, loop unrolling, instruction level parallelism, etc., can be used to improve computational efficiency. The processes can be performed on separate pieces of hardware (e.g., devices). Each API call is considered as a task, and the LLM-based tool transforms the code such that independent tasks can be distributed and run in parallel, as opposed to sequentially, which is what occurs when serial code is performed (and the code must be performed on a single piece of hardware).

The distributed version of the code generated by the LLM-based tool follows specific program semantics, which can be understood by an underlying runtime. Once the distributed code is generated by the LLM-based tool, the runtime component understands the program semantics and efficiently executes independent tasks within the program on a distributed computing devices in the proper order.

Embodiments of the present invention can avoid dependencies on specific AI models such as, e.g., ViperGPT™, to generate code, and tools such as, e.g., image_patch library, to perform tasks (functions, calls, etc.) with the code. Specific model and tool dependencies can be avoided by leveraging runtime APIs. The runtime API can dynamically discover available resources that can be used (e.g., LLMs and tools) and programmatically construct LLM prompts to have the LLM generate code that enables use of the resources. By avoiding specific models and tools for given tasks and allowing the runtime API to determine the appropriate tools, the code can be more customized for each response and responses tailored to a given query. For example, applying a runtime API to a given query can ensure a particular retrieval augmented generation (RAG) database is utilized. Other external tools are also contemplated.

The runtime APIs can be queried and retrieve metadata or other information about the available resources and then input the information into the LLM. The query to the runtime API can be either from the user query or another source. In other words, a natural language query can be input into the runtime API, or e.g., the user query can be input into an LLM to create a machine language/code query for the runtime API. The output of the runtime API can be input into the LLM along with the natural language query to form the serial and/or parallel code.

The framework for generating serial code which is then distributed/performed in parallel is initiated with an original natural language query. Once initiated, the framework dynamically discovers available tools through runtime APIs. Further, the framework programmatically constructs prompts to guide an LLM to generate serial code and then transform the code into distributed code, leveraging a step-by-step approach that improves performance and accuracy. Embodiments of the present invention are capable of this flexibility by selecting tools at runtime which enables the framework to adapt to diverse workflows while focusing specifically on optimization such as in cloud environments and for particular resources like cost, time, computational load, etc.

In an embodiment of the present invention, an artificial intelligence (AI) model being trained or executed on a cluster of computing devices can apply parallel tasks well and is suitable for using distributed code. AI models often compute the same type of calculation many times and can utilize GPUs because GPUs are designed to process the same task many times and can be stored on several different computing devices. This may be more efficient than performing the same task on a single computing device which may use a CPU instead, which is less efficient at performing the same task repetitively.

AI models can perform any number of tasks such as image classification, object detection, segmentation, pose estimation, speech recognition, speaker identification, sound event detection, named entity recognition, sentiment analysis, semantic similarity, text generation, code generation, machine translation, summarization, image synthesis, video generation, text to speech, music generation, game-playing, robotics control, route optimization, multi-agent coordination, symbolic reasoning, theorem proving, multi-hop question answering (QA), commonsense reasoning, recommender systems, dialogue agents, personal assistants, adaptive learning systems, anomaly detection, time series forecasting, clustering/classification/regression, feature selection and dimensionality reduction, etc. This is not intended to be limiting, and this list is non-exclusive.

In some embodiments of the present invention, code generation can be associated with Synthia and code execution can be associated with Hermod.

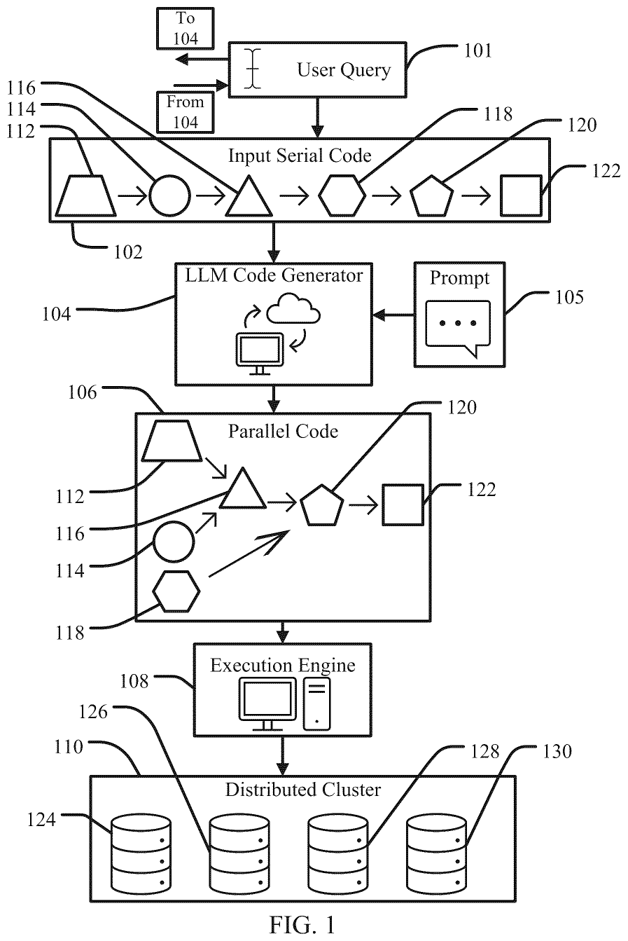

Referring now in detail to the figures in which like numerals represent the same or similar elements, and initially to FIG. 1, a high-level architecture of the code generation framework is illustrated. The LLM-based tool can be an LLM code generator 104 which focuses on improving the performance of the input serial code 102. Performance of the input serial code 102 can be defined as the time taken to execute the code and generate an output (e.g., latency of code execution). Other performance metrics are also contemplated.

LLM code generator 104 can leverage concepts from parallel processing and generate distributed code which decomposes input serial code 102 into parallel tasks. The parallel tasks that were originally in input serial code 102 can then be executed concurrently or at least partially concurrently on a cluster of computing devices. In other words, embodiments of the present invention have more of an effect on high-level algorithmic improvements than actual implementation of the code itself (e.g., low-level algorithmic improvements). This improves the functioning of a computer by separating tasks. In situations where the network is made up of different types of GPUs made for different purposes, the distributed code can be generated to consider this can allocate GPU to tasks accordingly.

LLM code generator 104 uses a parallel computation model for execution on multiple computing devices rather than serial code execution, which occurs on a single computing device. This is because a distributed cluster 110 that performs parallel code 106 can be tasked with performing the same portion of the functions of the code many times (instead of all the functions in the code) such as training a neural network. GPUs are optimized for performing the same task instead of a variety of tasks, and there are efficiencies in economies of scale over performing input serial code 102 with CPUs, making parallel computing with GPUs preferable to serial computing. In an embodiment of the present invention, to fully appreciate the distributed cluster, distributing the execution of these AI models on separate GPUs is preferred, though execution on a single GPU or another type of computing device, e.g., server, is possible.

LLM code generator 104 leverages generative artificial intelligence (GenAI) and LLMs to automatically generate distributed version of input serial code 102 according to a user query 101. User queries 101 and prompts 105 can be natural language inputs, images, videos, audio, or another types of input that the LLM is capable of processing. User query 101 is the desired goal in non-technical terms (though user query 101 can be in technical terms if preferred), while prompt 105 is a machine generated input to an AI model to generate parallel code 106. Prompt 105 can be generated with a runtime API to determine which LLM and tools are to be used in the serial code 102 and parallel code 106.

User query 101 can be used to generate functional input serial code 102. This can be done by querying a runtime API to retrieve metadata about the available tools. Commands in prompt 105 such as, e.g., kubectl_get_functions and kubectl_get_functions <function-name> -o yaml, provide detailed documentation, including the tool's functionality, input parameters, and output schemas. An example runtime API output can be for a Grounded Language-Image Pre-training (GLIP) function. Information can be embedded into prompt 105 alongside user query 101 to be used in execution engine 108. User query 101 guides a model to generate serial code (e.g., in Python™) tailored to the tools available in the runtime. Since functional, input serial code 102 may suffer from inefficiencies such as, e.g., GPU idle time during CPU-bound operations and underutilization when lightweight tasks run on large GPUs, the need for distributed code generation is apparent to cure these inefficiencies.

Updated prompts 105 are constructed using information from the runtime API, which enables the model (LLM code generator 104) to identify independent API calls in the serial code and refactor them for concurrent execution (parallel code 106). Additionally, elements from the prompt structure can be incorporated to dynamically adapt parallel code 106 to include runtime-discovered tools. This ensures LLM code generator 104 generates parallel code 106 tailored to the specific environment.

By enabling concurrent execution of independent API calls, parallel code 106 can utilize multiple smaller server instances instead of relying on a single large server. This reduces idle server time, improves resource utilization, and lowers operational costs, among other benefits.

LLM code generator 104 includes an LLM which is trained to automatically transform input serial code 102 into parallel (distributed) code 106 which can be executed on distributed cluster 110. Input serial code 102 and parallel code 106 can be generated at the same time or at different times. In further embodiments of the present invention, user query 101 can be input directly into LLM code generator 104 to produce input serial code 102 and parallel code 106 at the same time (e.g., input serial code 102 is an output from the LLM generator 104 instead of an input). Alternative embodiments of the present invention can include having input serial code 102 be an output of the LLM code generator 104 but input serial code 102 is be generated before parallel code 106. Input serial code 102 can be generated by any number of LLMs.

Input serial code 102 and parallel code 106 can be written in any number of computer languages including C/C++, Python™, Java™, JavaScript™/TypeScript™, C#, Go™, Rust™, Swift™, Kotlin™, Ruby™, PHP™, Perl™, SQL#™, etc. Other languages are also contemplated.

To execute tasks on separate computing devices, the LLM code generator 104 uses special program semantics, which use function calls to “services” on the component. The program semantics indicate which section of the code can be executed on a given computing device, separate from the others. The component can be an execution engine 108. Execution engine 108 can receive and execute parallel code 106 on distributed cluster 110. Through function calls, independent tasks can be executed in parallel on distributed cluster 110. The function calls can be independent API calls. This allows for dynamic, flexible, and adaptable code execution systems. For example, computing devices can be called for certain tasks or functions and otherwise available for other functions. In other words, the computing devices can be pooled such that they can be called by different entities performing different tasks. These computing devices can be employed when there is code to execute and be on standby otherwise so that other entities can perform other functions with the same computing devices at a later time or concurrently. Alternatively, depending on other system factors different computing devices can be employed to perform the same task. To put this another way, e.g., if a computing device is preferred to execute a certain function but is allocated to another, unrelated task or function, a different computing device can be assigned to perform the given function, rather than waiting for the preferred computing device. By reserving servers only for the duration of individual service calls, the runtime minimizes idle time and enables cost-efficient (and energy efficient, etc.) execution.

The runtime architecture processes requests through service queues, where each API call is transparently mapped to a server running the associated AI model. This design facilitates efficient resource sharing across multiple workloads, further reducing the cost, energy, etc. of cloud-based deployments. By handling workloads dynamically, the runtime ensures scalable and adaptable execution of vision applications.

In one embodiment of the present invention the code can be generated and executed in Python™ programing language and use the asyncio library to execute code concurrently. Other methodologies and similar or equivalent libraries in other languages are also contemplated such as, e.g., Trio™, Curio™, Twisted™, Tokio™, etc.

LLMs for responses through prompts 105 to achieve the desired results. Prompt 105 can be engineered to form parallel code 106 that can be executed in parallel by forming specific signals in the code to perform selected functions or portions of the code concurrently. These signals can be functions from a module in the programming language that allows code to be executed concurrently. Other signals are also contemplated.

In embodiments of the present invention, user query 101 is intended to denote the input that derives input serial code 102 and prompts 105 are inputs to LLM code generator 104 that derive parallel code 106. Since LLMs are quite sensitive to prompt 105 (and user query 101), rather than manually writing prompt 105, a training phase in LLM code generator 104 automatically generates a system prompt 105. System prompt 105 will guide the LLM to generate syntactically correct and performant distributed code for the given input serial code 102 (while ensuring that parallel code 106 performs the same functions as input serial code 102). Syntactically correct can mean that the program syntax can be correct and the program can run. Performant can mean the code can take advantage of the parallelism in the distributed code and run faster than the serial version.

The tasks performed in input serial code 102 and parallel code 106 are illustrated as shapes in sequential order. In input serial code 102 the first function to be performed is a trapezoid 112, then a circle 114, then a triangle 116, then a hexagon 118, then a pentagon 120, and then a square 122. This linear process can be separated onto several different computing devices to make the code more efficient through parallel processing. Instead, trapezoid 112, circle 114, and hexagon 118 can be performed at the same time (in parallel) on different computing devices which can reduce the execution time of the code. Further, these computing devices can be configured to optimize each process on them through the selection of specific hardware or other means. Computing devices can be configured and optimized to serve specific API calls.

Trapezoid 112 can embody code such as, e.g., defining variables, etc. Circle 114 can perform other operations concurrently with trapezoid 112, such as, e.g., importing modules. Triangle 116 can then execute the function defined using the variables from trapezoid 112 and a module from circle 114. While trapezoid 112 and circle 114 are being performed, hexagon 118 can also be performed concurrently since there is no dependency on hexagon 118 from triangle 116. The output from triangle 116 and hexagon 118 can then be combined in pentagon 120. The output from pentagon 120 can then be displayed graphically or returned in square 122.

In an exemplary embodiment of the present invention, execution engine 108 can use four servers, server one 124, server two 126, server three 128, and server four 130. While only three actions act most can be performed at one in the code illustrated in FIG. 1, an additional server may be present to supervise the other servers, perform other tasks, provide redundancy, or otherwise be used. Server one 124 can perform the function described in trapezoid 112 while server two 126 can perform the function described in circle 114 and server three 128 can perform the function described in hexagon 118. In alternative embodiments of the present invention, the servers can be optimized for a given task or can perform the next task in the sequence.

Execution engine 108 can select server one 124, server two 126, server three 128, and server four 130 based on any number of criteria such as, e.g., cost of using third-party servers, availability, number of servers (computing devices) necessary, etc. These criteria can also be performance criteria such as time to complete the code (or portions of the code), or latency, etc. Once the servers are selected, execution engine 108 can filter and order the preference of the servers based on one or several heuristics. The heuristics can be to optimize for latency or runtime, or available servers when the code is requested to be executed, cost to use servers, minimize idle time of the servers, maximize utilization of the servers, etc., or some combination thereof. The heuristic can be a secondary consideration to identify an order of preferentially filtering/selecting servers. If the most preferential server is already in use, a second most preferential server can be employed, etc.

For example, the number of servers or types of servers that execute the code can be selected based on minimum (or maximum) requirements. To put this another way, in the example, execution engine 108 can select server one 124 and server two 126 that are satisfactory at meeting requirement A (latency), server two 126 can have a lower (better) latency than server one 124, but server two 126 can “fail” requirement B (availability) while server one 124 can meet requirement B. Server one 124 can be selected because that server is more preferential since the server can be employed now, rather than waiting for server two 126 which can be used later, even though server one 124 does not have as low a latency as server two 126.

Execution engine 108 can select server one 124 since both requirements A and B are met, even though requirement is not as high performing as other hardware. Performance criterion and secondary considerations can be the same, different, or interchangeable. The performance criterion and secondary considerations can be reevaluated on a schedule, after performance of a set number of functions/tasks/calls, after performance of specific functions/tasks/calls, upon user command, etc., so that server two 126 is used once available. If the computing capacity of one type of server is not enough to meet the computational demand, the utilization of the most preferred type of server can be maximized then the remaining computing demand be allocated to the next most preferred server type, and so on.

Any number of requirements can be selected and have various importances. The importance of each requirement can be set manually or dictated by the code or some other predetermined criteria. The performance criteria and secondary considerations can be for execution of input serial code 102 as a whole or portions of input serial code 102. The selection and filtering (filtration) of performance criteria and secondary considerations can also change during run-time and adaptively changed according to manual settings, heuristics, etc. (e.g., being dynamically redistributed).

To be clear, embodiments of the present invention can be integrated with low-level optimization of the code which make each of the functions represented by the shapes more efficient. Embodiments of the present invention change when and where the code is executed (e.g., concurrently on different machines), not but not the manner in which the code is executed, which can be improved by other techniques in conjunction to those mentioned herein.

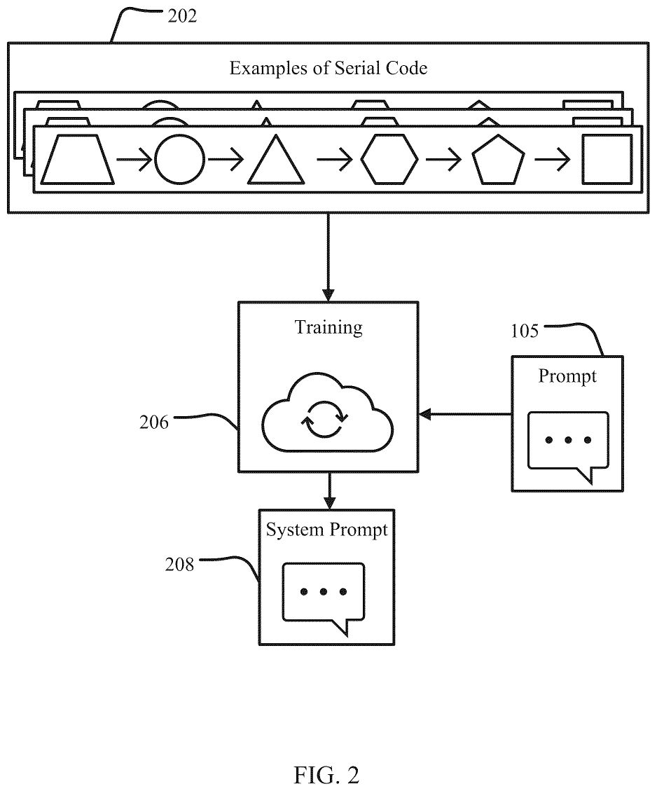

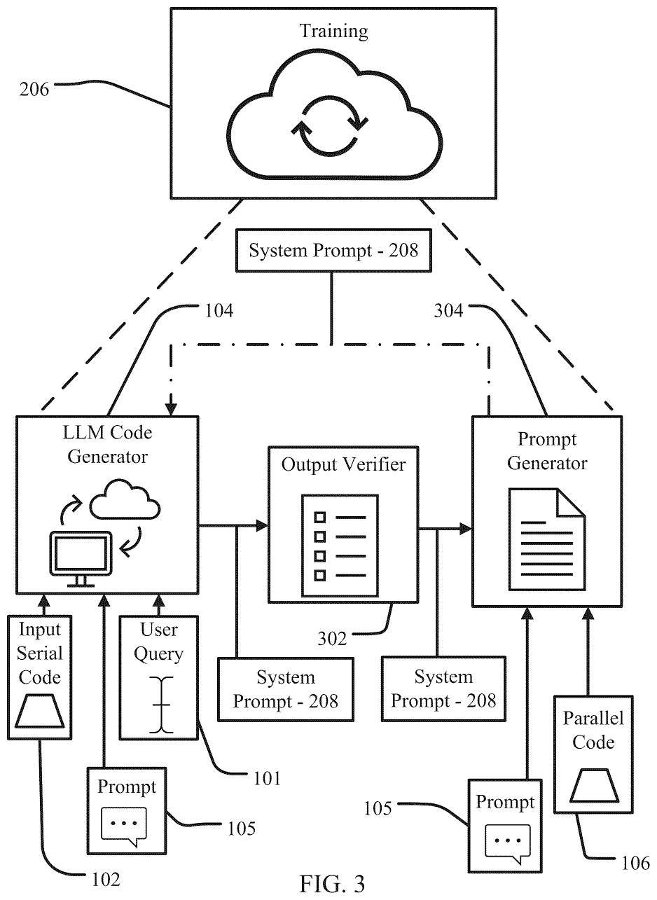

Referring to FIGS. 2 and 3, block diagrams of the training of LLM code generator 104 are illustrated in greater detail. The goal of the training phase is to derive a system prompt 208 which, given input serial code 102 and prompt 105, generates syntactically correct and performant parallel code 106 (FIG. 1), which can be executed on a distributed cluster 110 (FIG. 1). Input to the training phase 206 includes several example serial codes 202 along with corresponding prompt 105 for which there is a known ground truth output. The known ground truth is the generated output from the serial code which can be compared with the output from the generated distributed code.

Training phase 206 is started with a basic seed prompt (prompt 105) and iteratively revises prompt 105 automatically until syntactically correct and performant versions of the parallel code 106 (FIG. 1) are generated. Parallel code 106 (FIG. 1) can perform the same functions as the equivalent code in the several examples of serial code 202 and do so faster. Embodiments of the present invention maintain the accuracy and functionality of several examples of serial codes 202 while improving the code by reducing runtime (e.g., making the runtime faster). In other words, parallel code 106 has no functionality, operability, or other degradation in code quality (to a reasonable, predetermined degree, if at all).

To implement training phase 206, three different LLMs can be used. LLM code generator 104 generates distributed code for user query 101 and several example serial codes 202 based on prompt 105. During training phase 206, the prompt 105 for LLM code generator 104 continues to be revised. Revision occurs whenever prompt 105 cannot generate syntactically correct and performant parallel code 106 (FIG. 1).

Another LLM used is output verifier 302 which compares an output for a given system prompt 208 in several example serial codes 202 with an output for a given system prompt 208 in parallel code 106 (FIG. 1) and determines whether they match. If prompt 208 matches, then system prompt 105 for LLM code generator 104 stays constant, if not, another LLM is invoked to revise prompt 105.

A different LLM used during training phase 206 can include prompt generator 304 which refines prompt 105 for LLM code generator 104 whenever the generated distributed code does not pass the standards of output verifier 302. Input to prompt generator 304 can include prompt 105, incorrect parallel code 106, and output from the serial and distributed code execution (system prompt 208). With these inputs, prompt generator 304 analyzes the reason prompt 105 was not able to generate a satisfactory version of parallel code 106 and then derives a new system prompt 208, which matches input serial code 102 better. Once training phase 206 is complete, LLM code generator 104 and prompt 105 are aligned to automatically generate parallel code 106.

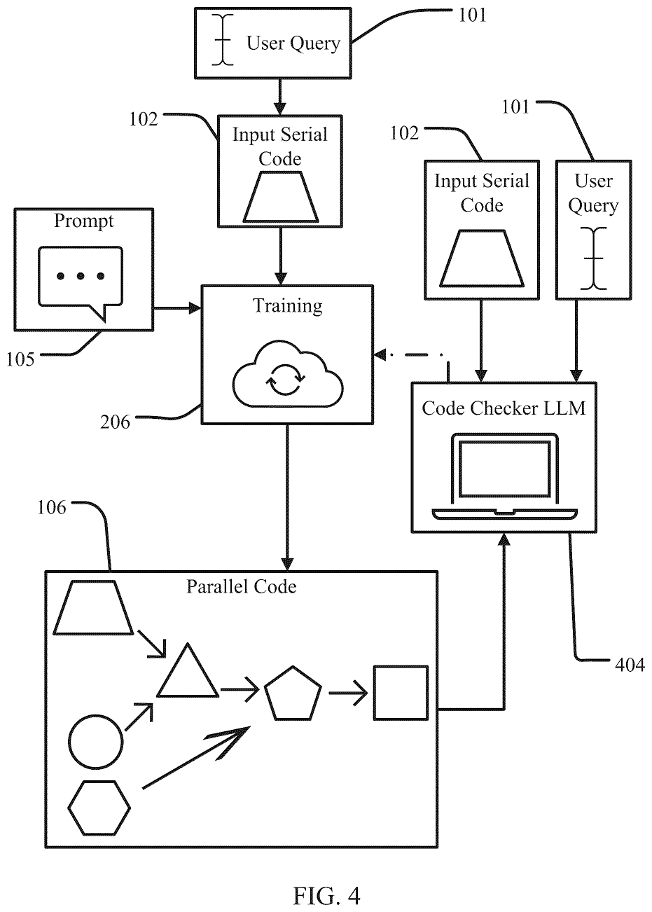

Referring to FIG. 4, a block diagram for inference generation of the LLM-based tool is illustrated. Once parallel code 106 is generated, the code is tested to determine whether the code is suitable for deployment or other use. To validate the performance of parallel code 106 another LLM is used. Code checker LLM 404 has as inputs user query 101, input serial code 102, and parallel code 106. With these inputs, code checker LLM 404 compares the two codes (parallel code 106 and input serial code 102) and determines whether parallel code 106 can generate the same output as input serial code 102. If the code passes, then the suggested parallel code 106 is given as the final output. If not, then another version of parallel code 106 is generated and compared. This continues until a suggested parallel code 106 version passes.

In further detail, several serial code 102 examples are executed to achieve output for verification purposes. For each input serial code 102, a corresponding parallel code 106 is also generated, with a corresponding output. Then, the two outputs are compared. If parallel code 106 is faster than the input serial code 102 (performant) and the outputs match, then the next input serial code 102 example is tested. If not, then a new prompt 105 is generated and applied to LLM code generator 104. The failed test is repeated until a configured maximum number of attempts to determine if the test is passed, e.g., generated parallel code 106 is performant and the output matches input serial code 102. Whenever a previously failed test passes, the process is repeated from the beginning to ensure that the refined system prompt 105 has not changed behavior for previously passed tests. This process continues until all tests pass for a minimum configured number of times. Once completed, the last system prompt 105 is used as the final instructions.

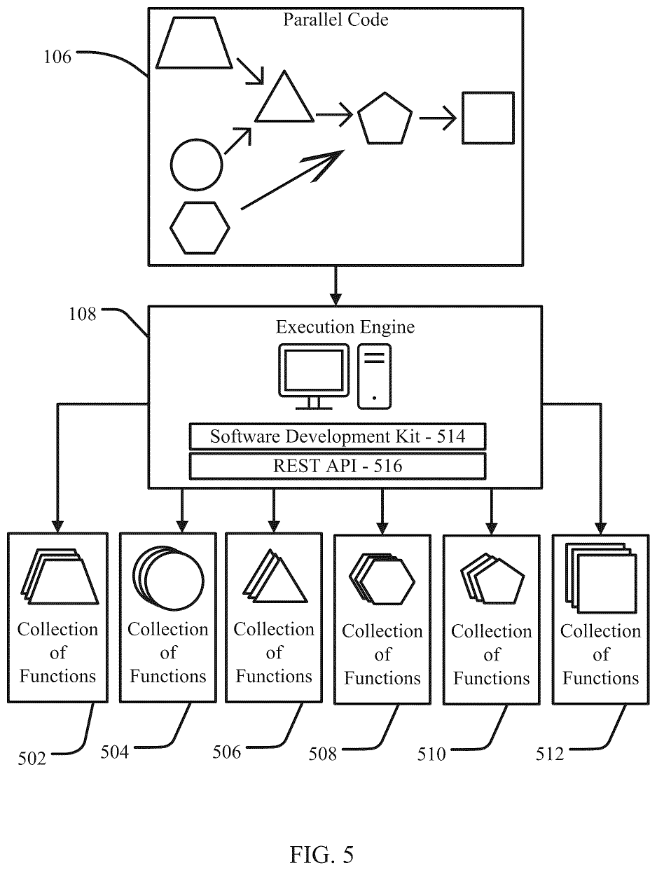

Now referring to FIG. 5, execution engine 108 is described in further detail. While LLM code generator 104 (FIG. 1) automatically generates a distributed version of input serial code 102 (FIG. 1) to improve code performance, execution engine 108 focuses on efficient execution of the generated parallel code 106 on a set of distributed computing devices, e.g., cluster of computer devices (distributed cluster 110). Input to execution engine 108 is the parallel code 106 generated by LLM code generator 104.

Since LLM code generator 104 is aware of the underlying runtime, parallel code 106 already incorporates special program semantics to invoke function calls to services on execution engine 108. These function calls are understood by execution engine 108 and executed efficiently on the underlying distributed infrastructure (e.g., distributed cluster 110). These function calls are indications in parallel code 106 that separate the code into different computing devices. In other words, the function calls are indicators in the code that reflect when parallel operations can be performed. In some embodiments of the present invention. Programming language libraries can be imported into the code and have functions to indicate which functions can be performed concurrently.

In some embodiments of the present invention, execution engine 108 can be paired with third-party solutions, such as, e.g., Kubernetes™, though third-party solutions are not necessary. The third-party solutions can be container orchestration frameworks that act as an “operator” to package, deploy, and manage Kubernetes™ applications. The operator exposes a new “kind” called “function,” through which various functions as a service can be deployed on the third-party solution. The “kind” is a Kubernetes installed to create clusters using docker container nodes. The service is a way to expose a set of pods as a network service. These functions are stateless and serverless since execution engine 108 manages the computing devices and is transparent to the source writing or invoking the functions.

Various functions can be deployed on execution engine 108, each performing a specific task (e.g., portion of parallel code 106 that is on a separate computing device). Each function forms a “deployment” and execution engine 108 creates multiple copies/instances of each function and executes them as “pods” within the third-party solution. There are several ways to invoke a function that runs on execution engine 108. For example, several copies of the function represented by trapezoid 112 can form collection of functions 502. A collection of functions 504 can be for circle 114, a collection of functions 506 can be for triangle 116, a collection of functions 508 can be for hexagon 118, a collection of functions 510 can be for pentagon 120, and a collection of functions 512 can be for square 122.

One approach to invoke the function includes applying a software development kit 514 (SDK). A purpose of SDKs 514 is to provide a collection of tools, libraries, documentation, code samples, processes, guides, etc., which can create applications integrated into specific third-party platforms, operating systems, frameworks, or programming languages. SDK 514 is generally developed by a third-party. Execution engine 108 exposes SDK 514 to implement different functions/services. In other words, SDK 514 has a “run” function, which takes in a callback function as an argument (parallel code 106). Execution engine 108 invokes this callback function whenever there is a request on a particular function/service as determined by LLM code generator 104.

Another way to invoke the function that runs on execution engine 108 includes a representational state transfer (REST) API 516 which also allows interfacing with the function/service. The execution engine 108 exposes functions and services via dedicated endpoints. Upon receiving a “POST” request with the proper parameters/inputs, the execution engine 108 processes POST request and returns a response.

To execute requests received on different functions/services (either through SDK 514 or REST API 516), execution engine 108 internally maintains a queue for each function/service. Whenever a request is received for any function, the request is put at the end of the queue corresponding to the function. Each queue is processed independently to serve function requests. Execution engine 108 maps each request to one of the available copies (“pods”) of the function and executes them on a first-come, first-serve basis. At the time of execution, if the request is no longer valid, e.g. if the sender no longer needs the response, then execution engine 108 automatically removes the request from the queue. By having separate queues and processing requests concurrently, execution engine 108 ensures efficient execution of parallel code 106 on the underlying cluster of computing devices. This is true not only processing requests between various functions, but also within a specific function.

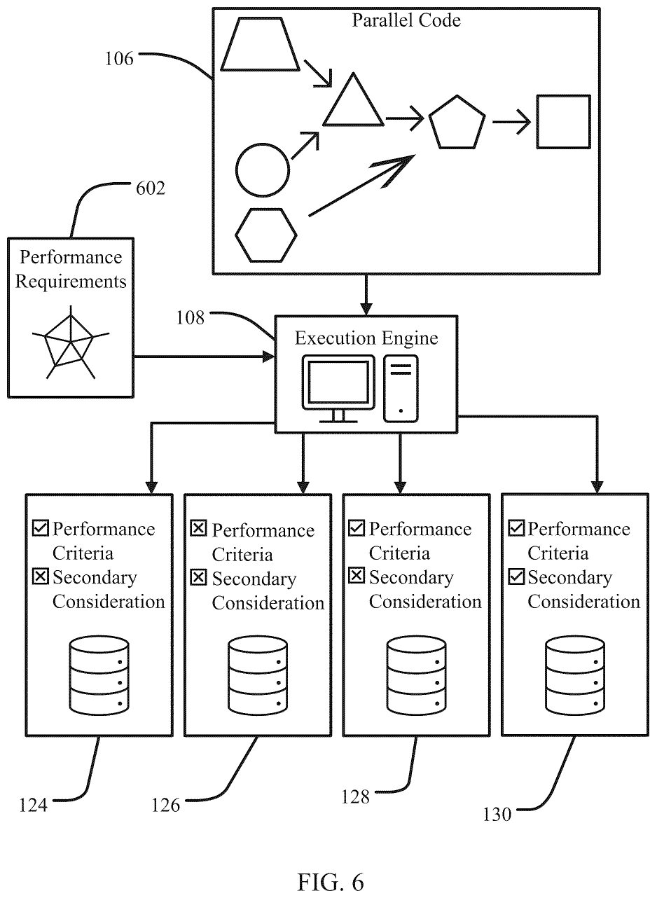

Referring to FIG. 6, a block diagram for selecting at least one server is illustrated. Parallel code 106 can be input into execution engine 108. Performance requirements 602 can also be input into execution engine 108. Performance requirements 602 can be the performance criteria and secondary consideration(s). The selection of a server can be predicated on performance requirements 602 being met, where the evaluation of the secondary consideration is performed if the performance criteria is met. In other embodiments of the present invention, a secondary consideration can be evaluated even when the performance criteria for that server fails.

Performance requirements 602 can include multiple different types of requirements or one type of requirement. The performance criteria can be of the same type as the secondary consideration (e.g., both the performance criteria and secondary consideration are latency), or can be different types (e.g., performance requirement is latency, secondary consideration is workload type). There can also be more than one performance criteria and/or more than one secondary consideration to define the available servers and create a preferential list of available servers to use. The list of preferential available servers can be sequential, or place servers into tiers, weighted scoring, multi-factor scoring (e.g., consider both performance criteria and secondary consideration in the preferential list), pairwise comparison, forced ranking (no ties), etc. Execution engine 108 can go through the list to prioritize the servers to be used to select the server type highest on the list that is available. Multiple types of servers can be selected based on availability, such as e.g., if the most preferential type is at capacity, a next more preferential server can be selected until all computing needs are satisfied.

In an embodiment of the present invention, server one 124 can meet the performance criteria and meet the secondary consideration. Server two 126 can fail the performance criteria and either fail or not be evaluated for the secondary consideration. Server three 128 can meet the performance criteria and meet the secondary consideration. Server four 130 can meet the performance criteria and meet the secondary consideration. Since, a secondary consideration can be a heuristic for setting an order in a list, “meeting” the secondary consideration can be used for assigning a place in the list for each server. If there is no information about the secondary consideration for that particular server or an inability to determine the listing in the preferential list on that secondary consideration the sever can “fail” the secondary consideration and either be listed at the end of the list or not listed entirely. Since server two 126 fails the performance consideration, server two 126 is not listed in the preferential list for performing execution engine 108. Server one 124, server three 128, and server four 130 all meet the performance criteria and are listed on the preferential list. Based on the values of the secondary consideration the order of servers (server one 124, server three 128, and server four 130) can be determined.

In some embodiments of the present invention execution engine 108 can estimate and output cost, time, and other information about performing parallel code 106 prior to execution for informed user decision making prior to actually executing the code. Execution engine 108 can make recommendations for server selection based on this output. Execution engine 108 can also track cost, time, etc., while executing the code and providing real-time information. For example, if a project using parallel code 106 has a set budget for training a model or performing a function, execution engine 108 can keep track of the amount of budget spent and give warnings when approaching the limit. In alternative embodiments of the present invention, execution engine 108 can automatically modify the selection of servers to meet certain restraints such as time and cost. These restraints can be input/set ad-hoc or in advance or modified based on user preferences.

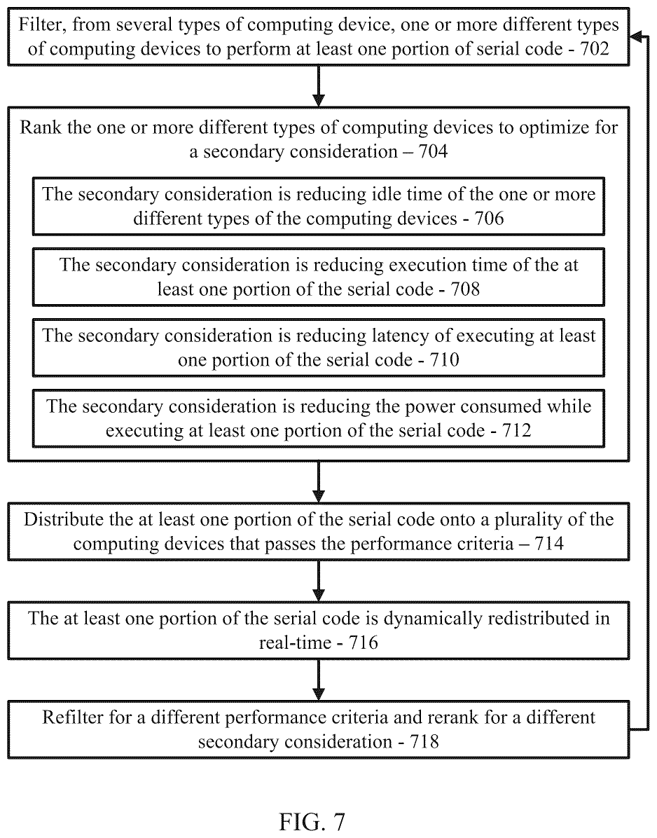

Referring to FIG. 7, a flow diagram demonstrating a method for generating and executing the distributed code (in the cloud) is illustrated. In block 702, several types of computing device can be filtered from to select one or more different types of computing devices to perform at least one portion of serial code. The one or more different types of the computing devices selected pass a performance criteria for the at least one portion of the serial code. The performance criteria can be ability to complete the code, e.g., within a certain time, within certain power demands, etc. Being selected can include being in a collection of possible computing devices used, rather than actually being used.

In block 704, the one or more different types of computing devices are ranked to optimize for a secondary consideration, the secondary consideration being a heuristic to determine a preferential order of the computing devices for execution of the at least one portion of the serial code. In other words, the ranking of preferential computing devices gives a heuristic for deciding which computing devices to use out of several possibilities. The performance on the secondary consideration can give an order or preference to employ one of the selected computing devices. In other words, a highest ranked computing device in the preferential order can be first to be selected. If, however, that device is unavailable for some reason (e.g., prohibitively expensive to use, not enough power to function, all computing devices are already allocated for other uses, etc.), a second highest ranked computing device in the preferential order can be select, etc. The secondary consideration can be for a specific portion or portions of the code, or the entirety of the code.

In block 706, the secondary consideration is reducing idle time of the one or more different types of the computing devices. This can minimize the time of execution and cost of using third-party computing devices on a cloud. This can also minimize the power consumed to keep the computing device online and when not in use. In block 708, the secondary consideration is reducing execution time of the at least one portion of the serial code. In other embodiments of the present invention, the entirety of the code or specific functions/tasks/calls included within a portion of the serial code can be optimized for (e.g., select a computing device to complete a given task). In block 710, the secondary consideration is reducing latency of executing at least one portion of the serial code. The latency can be reduced any number of ways such as selecting computing devices in a specific geographic area, improve routing, reduce number of “hops,” optimize for caching, minimize synchronous dependencies, optimize for cold starts, optimize for operating system/network stack, and design tail latency, etc. The secondary consideration can also be for throughput, quality of service and reliability (such as e.g., jitter, tail latency, error rate, availability and uptime, service level objective compliance), resource utilization (such as e.g., CPU utilization, GPU utilization, memory utilization, network utilization), performance per watt, system responsiveness metrics (such as e.g., time to first byte, time to interactive, input lag), queuing and scheduling metrics (such as e.g., queue length, wait time, context switch rate, thread scheduling latency), distributed system metrics (such as e.g., consistency latency, commit latency, replication lag, skew/drift), etc. In block 712, the secondary consideration is reducing the power consumed while executing at least one portion of the serial code.

In block 714, the at least one portion of the serial code is distributed onto a plurality of the computing devices that passes the performance criteria, the at least one portion of the serial code being allocated to the one or more different types of the computing devices according to a most preferable type of the computing devices available according to the preferential order of the computing devices. In block 716, the at least one portion of the serial code is dynamically redistributed in real-time. The serial code can be evaluated for redistribution for all or a part of the code. The evaluation/distribution can also be time delayed or according to a schedule. The code can be evaluated for redistribution but be determined to be optimized, as is.

In block 718, a different performance criteria is refiltered for and/or a different secondary consideration is reranked for. The refiltering and reranking can occur due to changing priorities such as cost, time, and power availability.

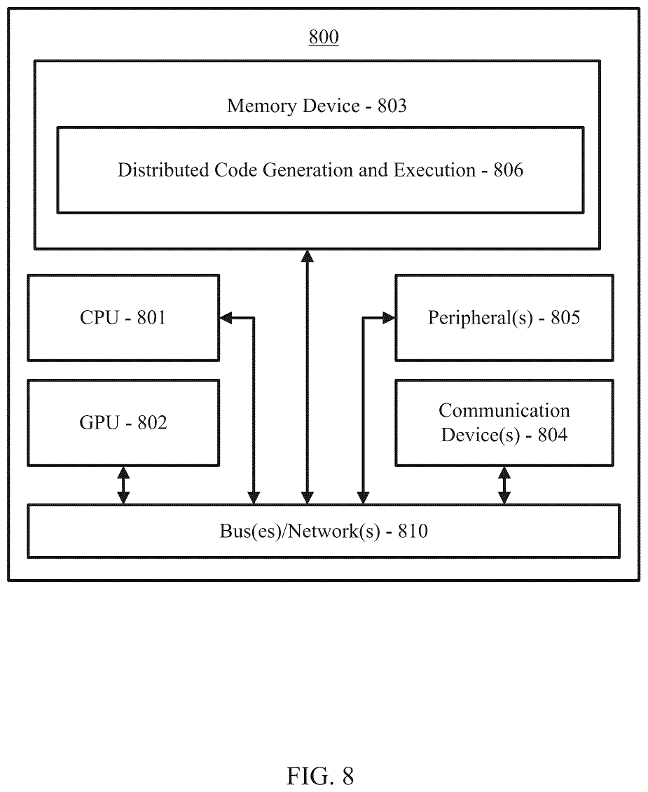

Referring to FIG. 8, a block diagram is shown for an exemplary processing system 800, in accordance with an embodiment of the present invention. The processing system 800 includes a set of processing units (e.g., CPUs) 801, a set of GPUs 802, a set of memory devices 803, a set of communication devices 804, and a set of peripherals 805. CPUs 801 can be single or multi-core CPUs. The GPUs 802 can be single or multi-core GPUs. The one or more memory devices 803 can include caches, RAMs, ROMs, and other memories (flash, optical, magnetic, etc.). The communication devices 804 can include wireless and/or wired communication devices (e.g., network (e.g., Wi-Fi®, etc.) adapters, etc.). The peripherals 805 can include a display device, a user input device, a printer, an imaging device, and so forth. Elements of processing system 800 are connected by one or more buses or networks (collectively denoted by the figure reference numeral 810).

In an embodiment of the present invention, memory devices 803 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 803 store program code or software 806 for distributed code generation and execution. The code generation and execution implement one or more functions of the systems and methods described herein for filtering, from several types of computing device, one or more different types of computing devices to perform at least one portion of serial code, wherein the one or more different types of the computing devices pass a performance criteria for the at least one portion of the serial code and ranking the one or more different types of computing devices to optimize for a secondary consideration, the secondary consideration being a heuristic to determine a preferential order of the computing devices for execution of the at least one portion of the serial code. The generation and execution software 806 further includes distributing the at least one portion of the serial code onto a plurality of the computing devices that passes the performance criteria, the at least one portion of the serial code being allocated to the one or more different types of the computing devices according to a most preferable type of the computing devices available according to the preferential order of the computing devices. The memory devices 803 can store program code for implementing one or more functions of the systems and methods described herein.

Of course, the processing system 800 may also include other elements (not shown), as readily contemplated by one of skill in the art, as well as omitting certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 800 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 800.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
filtering, from several types of computing device, one or more different types of computing devices to perform at least one portion of serial code, wherein the one or more different types of the computing devices pass a performance criteria for the at least one portion of the serial code;
ranking the one or more different types of computing devices to optimize for a secondary consideration, the secondary consideration being a heuristic to determine a preferential order of the computing devices for execution of the at least one portion of the serial code; and
distributing the at least one portion of the serial code onto a plurality of the computing devices that passes the performance criteria, the at least one portion of the serial code being allocated to the one or more different types of the computing devices according to a most preferable type of the computing devices available according to the preferential order of the computing devices.

2. The method of claim 1, wherein distribution of the at least one portion of the serial code is dynamically redistributed in real-time.

3. The method of claim 1, further comprising:
refiltering for a different performance criteria and reranking for a different secondary consideration.

4. The method of claim 1, wherein the secondary consideration is reducing idle time of the one or more different types of the computing devices.

5. The method of claim 1, wherein the secondary consideration is reducing execution time of the at least one portion of the serial code.

6. The method of claim 1, wherein the secondary consideration is reducing latency of executing at least one portion of the serial code.

7. The method of claim 1, wherein the secondary consideration is reducing power consumed while executing at least one portion of the serial code.

8. A system comprising:
a processor; and
a memory storing computer-readable instructions that, when executed by the processor, cause the processor to:
filter, from several types of computing device, one or more different types of computing devices to perform at least one portion of serial code, wherein the one or more different types of the computing devices pass a performance criteria for the at least one portion of the serial code;
rank the one or more different types of computing devices to optimize for a secondary consideration, the secondary consideration being a heuristic to determine a preferential order of the computing devices for execution of the at least one portion of the serial code; and
distribute the at least one portion of the serial code onto a plurality of the computing devices that passes the performance criteria, the at least one portion of the serial code being allocated to the one or more different types of the computing devices according to a most preferable type of the computing devices available according to the preferential order of the computing devices.

9. The system of claim 8, wherein distribution of the at least one portion of the serial code is dynamically redistributed in real-time.

10. The system of claim 8, wherein the memory further causes the processor to:
refilter for a different performance criteria and rerank for a different secondary consideration.

11. The system of claim 8, wherein the secondary consideration is reducing idle time of the one or more different types of the computing devices.

12. The system of claim 8, wherein the secondary consideration is reducing execution time of the at least one portion of the serial code.

13. The system of claim 8, wherein the secondary consideration is reducing latency of executing at least one portion of the serial code.

14. The system of claim 8, wherein the secondary consideration is reducing power consumed while executing at least one portion of the serial code.

15. A computer program product comprising a non-transitory computer-readable storage medium containing computer program code, the computer program code when executed by one or more processors causes the one or more processors to perform operations, the computer program code comprising instructions to:
filter, from several types of computing device, one or more different types of computing devices to perform at least one portion of serial code, wherein the one or more different types of the computing devices pass a performance criteria for the at least one portion of the serial code;
rank the one or more different types of computing devices to optimize for a secondary consideration, the secondary consideration being a heuristic to determine a preferential order of the computing devices for execution of the at least one portion of the serial code; and
distribute the at least one portion of the serial code onto a plurality of the computing devices that passes the performance criteria, the at least one portion of the serial code being allocated to the one or more different types of the computing devices according to a most preferable type of the computing devices available according to the preferential order of the computing devices.

16. The computer program code of claim 15, wherein distribution of the at least one portion of the serial code is dynamically redistributed in real-time.

17. The computer program code of claim 15, wherein the computer program code further causes the one or more processors to:
refilter for a different performance criteria and rerank for a different secondary consideration.

18. The computer program code of claim 15, wherein the secondary consideration is reducing idle time of the one or more different types of the computing devices.

19. The computer program code of claim 15, wherein the secondary consideration is reducing execution time of the at least one portion of the serial code.

20. The computer program code of claim 15, wherein the secondary consideration is reducing latency of executing at least one portion of the serial code.
